(19) United States
(12) Patent Application Publication
(10) Pub. No.: US 2013/0141437 A1
(43) Pub. Date: Jun. 6, 2013

(54) Data Display

(71) Applicants: Martti Tapani Ylikoski, Helsinki (FI); Ivan Bodunov, Espoo (FI); Martin Heisch, Berlin (DE); Sameer Babu Kunjumakal Kasim, Kerala (IN); Ricardo Marques, Azambuja (PT); Robert Pitchford, Basingstoke (GB)

(72) Inventors: Martti Tapani Ylikoski, Helsinki (FI); Ivan Bodunov, Espoo (FI); Martin Heisch, Berlin (DE); Sameer Babu Kunjumakal Kasim, Kerala (IN); Ricardo Marques, Azambuja (PT); Robert Pitchford, Basingstoke (GB)

(73) Assignee: NOKIA SIEMENS NETWORKS OY, Espoo (FI)

(21) Appl. No.: 13/697,195

(22) PCT Filed: Mar. 22, 2011
(86) PCT No.: PCT/EP2011/054328

§ 371 Date: Jan. 22, 2013

Related U.S. Application Data
(63) Continuation of application No. 12/776,863, filed on May 10, 2010, now abandoned.

(51) Int. Cl. G06T 11/20

(52) U.S. Cl. CPC G06T 11/206
USPC 345/440

(57) ABSTRACT

Methods and systems for displaying data are described. The display system extracts first data from a first data set, such as management system data. The first data includes one or more variables between a start time and an end time that may be user-defined. The display system uses the extracted data to populate a temporary database and process the data in the temporary database, such that there is no need to unduly interfere with the functionality of the management system. The data in the temporary database is processed to generate a plot value for each variable for each of a plurality of time slices. Finally, the plot values are presented as a series of images using a video processor to generate an intuitive visual representation of the data.

The present invention relates to the display of data.

Management data relating to complex systems provides very large amounts of data. Furthermore, data is typically being added to the data set all the time. Management systems typically monitor management data in order, for example, to determine when a fault condition has occurred.

It is very difficult for reporting tools to extract the data required to prepare reports and to display data without affecting the performance of the management system. Clearly, it is important in such circumstances that report generation does not adversely impact on the ability of the management system to provide its primary role (such as monitoring for fault conditions).

One solution to the problem defined above is to copy data from the management system into a separate database that can be used by reporting tools to prepare reports. In such an arrangement, the reporting tools do not need to access the main management system data and so the running of reports has no impact on the normal running of the management system.

Although the copying of management data into a separate database is conceptually simple, there are problems. For example, in systems with very large data sets, the copying of data may take a significant amount of time, which may itself affect the performance of the management system. Further, the quantity of data typically included in a management system can make the redundant storage required by such an algorithm relatively expensive. Finally, such an arrangement typically regularly transfers a defined data set to a temporary store. Such a system does not always readily allow a user to specify the data set that should be used to generate the report.

A further problem with using very large data sets is providing a tool that enables the data to be presented to users in a meaningful manner. Users often want visual displays that can give an overview of the data set in an intuitive manner. Such displays are difficult to provide.

The present invention seeks to address at least some of the problems outlined above.

The present invention provides a method comprising: extracting first data from a first data set, wherein the first data relates to a first variable for a first entity between a first defined start time and a first defined end time (which could be used defined); populating a second data set with said first data; processing the data included in said second data set to generate a plot value for said variable for each of a plurality of time slices (typically contiguous time slices); and processing said plot values to create a series of images over time of said plot values.

The present invention also provides an apparatus comprising: a first processor adapted to receive first data from a first data set, wherein the first data relates to a first variable for a first entity between a first defined start time and a first defined end time, wherein the first processor is adapted to generate a plot value for said variable for each of a plurality of time slices (typically contiguous time slices); a second processor (which may be the same physical processor as said first processor) adapted to convert a plurality of plot values into a series of images of said plot values over time; and a display adapted to output the series of images.

The invention may further comprise extracting second data from the first data set, wherein the second data relates to a second variable for the first entity between the first defined start time and the first defined end time, wherein: populating the second data set includes populating the second data set with said second data; and processing the data included in the second data set includes generating a two-dimensional plot value for said first and second variables for each of a plurality of time slices.

Alternatively, the invention may further comprise extracting second and third data from the first data set, wherein the second data relates to a second variable for the first entity between the first defined start time and the first defined end time and the third data relates to a third variable for the first entity between the first defined start time and the first defined end time, wherein: populating the second data set includes populating the second data set with said second and third data; and processing the data included in the sec- and data includes generating a three-dimensional plot value for said first and second variables for each of a plurality of time slices.

Some forms of the invention includes extracting fourth data from the first data set, wherein the fourth data relates to a first variable for a second entity between a second defined start time and a second defined end time (which second start and end times could be different or the same as said first start and end times); populating a third data set (which may be provided as part of the same database entity as the second data set) with said fourth data; processing the data included in said third data set to generate a plot value for said variable for each of a plurality of (contiguous) time slices; and processing said plot values to create a series of images over time of said plot values.

Furthermore, the invention may include extracting fifth data from the first data set, wherein the fifth data relates to a second variable for the second entity between the second defined start time and the second defined end time, wherein: populating the second data set includes populating the second data set with said second data; and processing the data included in the second data set includes generating a two-dimensional plot value for said first and second variables for each of a plurality of time slices.

Alternatively, the invention may include extracting fifth and sixth data from the first data set, wherein the fifth data relates to a second variable for the second entity between the second defined start time and the second defined end time and the sixth data relates to a third variable for the second entity between the second defined start time and the second defined end time, wherein: populating the second data set includes populating the second data set with said second and third data; and processing the data included in the second data includes generating a three-dimensional plot value for said first and second variables for each of a plurality of time slices.

At least some of the defined start times and/or the defined end times may be defined by a user (for example at an input to a replication engine). This provides significant flexibility.

At least some of said variables may be defined by a user. Again, this provides significant flexibility,

The series of images over time of said plot values may be provided as a video image. By way of example, a video processor may be used to generate said video image.

The invention may include interpolating between adjacent plot values. The display of the apparatus of the invention may output at least some of said interpolated data. This increases the number of plot values in the displayed output.

Thus, the present invention provides methods, apparatus and systems for displaying data. The display system extracts first data from a first data set, such as management system data. The first data includes one or more variables between a start time and an end time that may be user-defined. The display system may use the extracted data to populate a temporary database and process the data in the temporary database, such that there is no need to unduly interfere with the functionality of the management system. The data in the temporary database may be processed to generate a plot value for each variable for each of a plurality of time slices. Finally, the plot values are presented as a series of images, typically using a video processor, to generate an intuitive visual representation of the data.

The present invention also provides a computer program comprising: code (or some other means) for extracting first data from a first data set, wherein the first data relates to a first variable for a first entity between a first defined start time and a first defined end time; code (or some other means) for populating a second data set with said first data; code (or some other means) for processing the data included in said second data set to generate a plot value for said variable for each of a plurality of (typically contiguous) time slices; and code (or some other means) for processing said plot values to create an image over time of said plot values. The computer program may be a computer program product comprising a computer-readable medium bearing computer program code embodied therein for use with a computer.

Exemplary embodiments of the invention are described below, by way of example only, with reference to the following numbered schematic drawings.

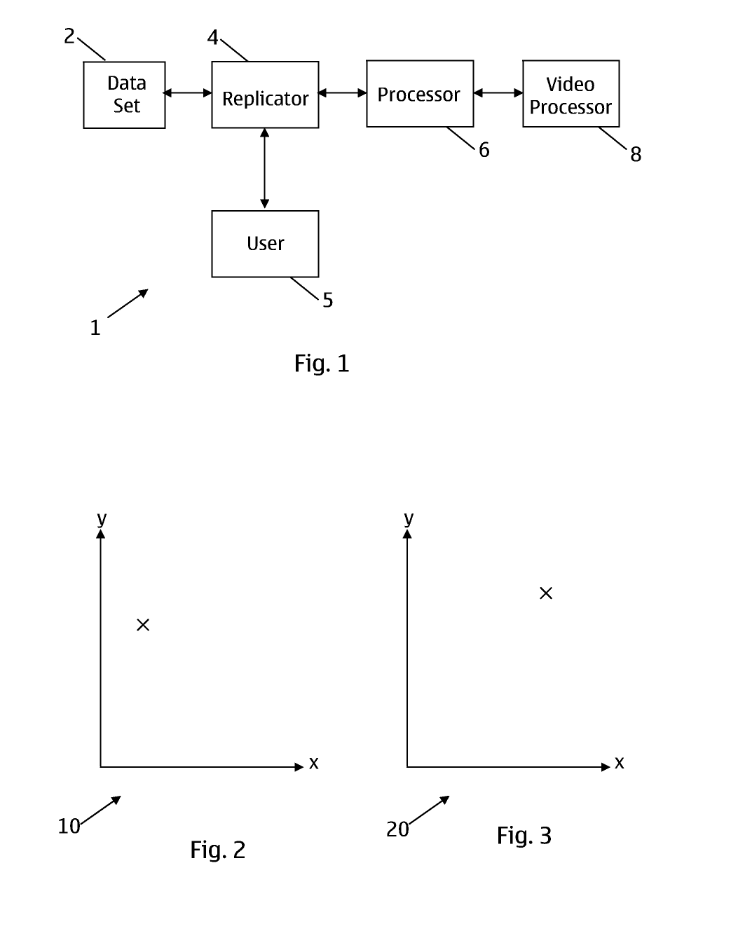

FIG. 1 is a block diagram showing a system in accordance with an aspect of the present invention;

FIG. 2 shows an exemplary data point that may be output by the system of FIG. 1;

FIG. 3 shows an exemplary data point that may be output by the system of FIG. 1;

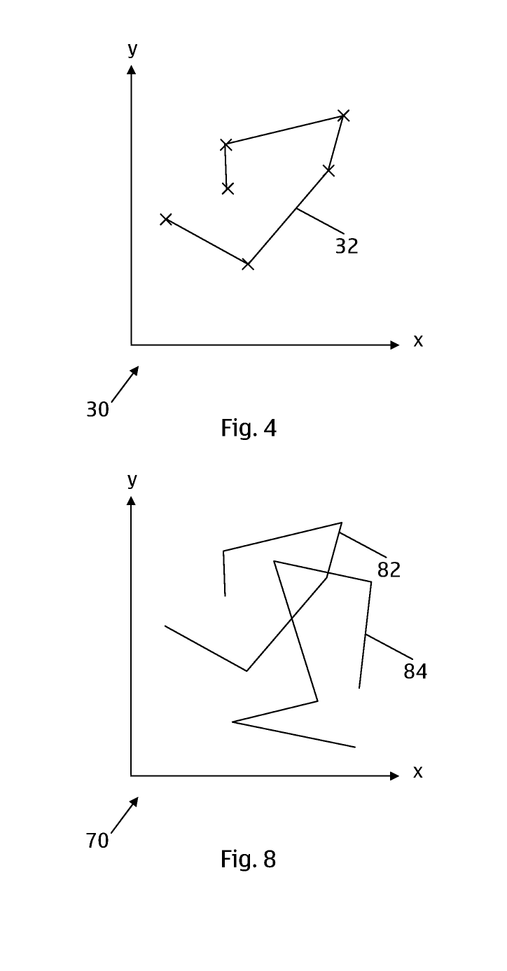

FIG. 4 shows an exemplary display that might be provided by the system of FIG. 1;

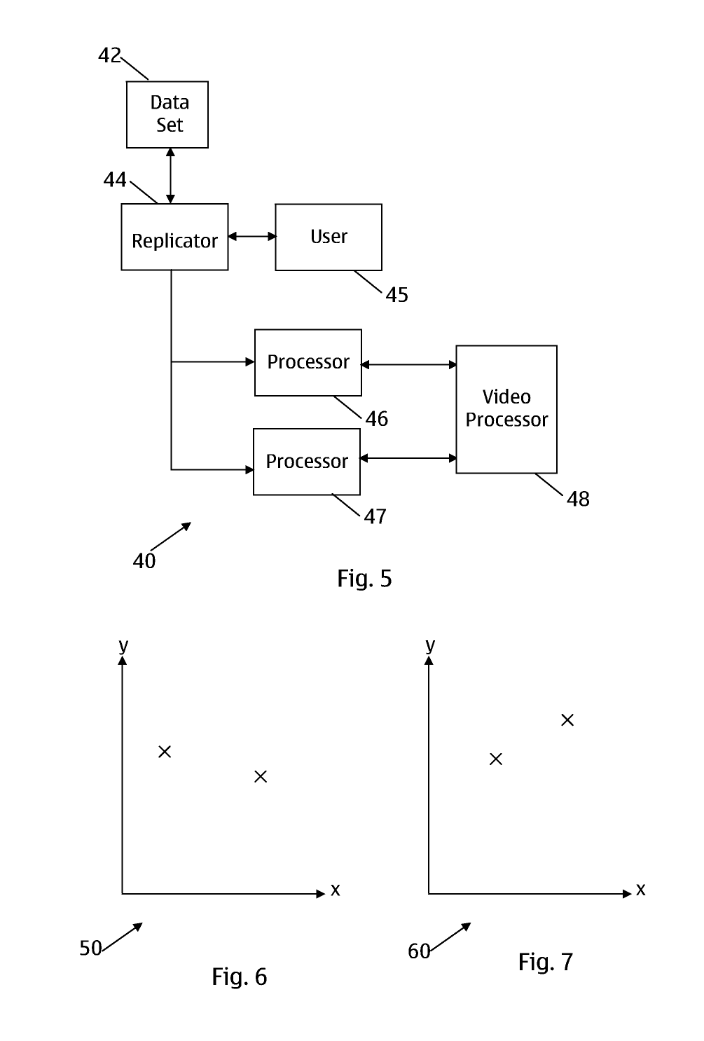

FIG. 5 is a block diagram showing a system in accordance with an aspect of the present invention; and

FIG. 6 shows an exemplary pair of data points that may be output by the system of FIG. 5;

FIG. 7 shows an exemplary pair of data points that may be output by the system of FIG. 5; and

FIG. 8 shows an exemplary display that might be provided by the system of FIG. 5.

FIG. 1 is a block diagram showing a system, indicated generally by the reference numeral 1, in accordance with an aspect of the present invention.

The system 1 comprises a data set 2, a replicator 4, a processor 6 and a video processor 8. The data set 2 may, for example, be data output by a management system.

The replicator 4 obtains data from the data set 2 and provides that data to the processor 6. The data set 2 is typically a very large data set and the processor 6 is required to process only a small part of that data. By using a replicator to obtain and provide the data required by the processor, the processor can process that data, without impacting unduly on the performance of the source of the data (e.g. a management system).

The replicator 4 has an input from a user 5. The user may be able to control the data that is provided to the processor 6.

For example, in the examples described in detail below, the user may be able to specify start and/or end times for the data provided to the processor 6.

The processor obtains data for a number of variables for a number of entities. Those variables typically change over time. The processor is used to generate a series of plots for one or more variables, so that the video processor can display how those plots change over time.

FIG. 2 shows an exemplary data point, indicated generally by the reference numeral 10, that may be generated by the processor 6. The data point has two dimensions (and x-dimension and a y-dimension). By way of example, the x-dimension may show the number of faults reported in a particular system between a first time and a second time. The y-dimension may show the average time to repair those fault in that time period.

FIG. 3 shows an exemplary data point, indicated generally by the reference numeral 20, that may be generated by the processor 6. The data point shows the same two-dimensional data as in FIG. 2, but for a different time period. Thus, in the exemplary time period of FIG. 3, the number of faults reported in a particular system (shown on the x-axis) is significantly higher that in the exemplary time period of FIG. 2. Furthermore, in exemplary time period of FIG. 3, the average time to repair the faults in that time period is slightly higher than in the exemplary time period of FIG. 2.

The video processor 8 is used to convert individual data points generated by the processor 6 (as shown in FIGS. 2 and 3) into a video image showing how the data changes over time.

FIG. 4 shows an exemplary display, indicated by the reference numeral 32, that might be provided by the output of the video processor 8. The display 32 shows how the 2-dimensional data changes over time. The representation of FIG. 4 shows all of the data points display, whereas, of course, the output of the video processor may only show one data point at a time.

The data points output by the processor 6 are shown in FIG. 4 with a “x” symbol. The lines joining data points shown in the display 32 may not be output by the video processor (i.e. the processor may only show the determined data points). Alternatively, the lines joining the data points may be generated by an interpolating engine (not shown) that interpolates between data points. Such an arrangement may give a more convincing video output. The interpolating engine may form part of the video processor 8.

FIG. 5 is a block diagram showing a system, indicated generally by the reference numeral 40, in accordance with an aspect of the present invention.

The system 40 comprises a data set 42, a replicator 44, a first processor 46, a second processor 47 and a video processor 48. The data set 42 may, for example, be data output by a management system.

The replicator 44 obtains data from the data set 42 and provides that data to the first processor 46 and the second processor 47. The data set 42 is typically a very large data set and the processors 46 and 47 are required to process only a small part of that data. By using a replicator to obtain and provide the data required by the processors, the processors can process that data, without impacting unduly on the performance of the source of the data (e.g. a management system).

As described in detail below, the first processor 46 may receive data relating to a first entity and the second processor 47 may receive data relating to a second entity.

The replicator 44 has an input from a user 45. The user may be able to control the data that is provided to the processors 46 and 47. For example, in the examples described in detail below, the user may be able to specify start and/or end times for the data provided to the processors. The start and end times might typically be the same for both processors, but this is not essential to all embodiments of the invention.

In an embodiment of the invention, the first processor 46 receives data for a number of variables for a first entity.

Those variables typically change over time. The processor is used to generate a series of plots for one or more variables, so that the video processor 48 can display how those plots change over time. The second processor receives data for a number of variables for a second entity. Those variables also typically change over time. The second processor 47 is used to generate a series of plots for one or more variables, so that the video processor 48 can display how those plots change over time. As described below, the video processor 48 receives data relating to the plots from both the first processor and the second processor and generates a combined image showing the outputs of both.

FIG. 6 shows a pair of exemplary data points, indicated generally by the reference numeral 50, that may be generated by the processors 46 and 47. The data points each have two dimensions (and x-dimension and a y-dimension). As in the example described above, the x-dimension may show the number of faults reported in a particular system between a first time and a second time. The y-dimension may show the average time to repair those fault in that time period. The data points provided by the first processor 46 may show fault data relating to a first location (e.g. San Francisco). The data points provided by the second processor 47 may show fault data relating to a second location (e.g. Los Angeles).

FIG. 7 shows a pair of exemplary data points, indicated generally by the reference numeral 60, that may be generated by the processors 46 and 47. The data point shows the same two-dimensional data as in FIG. 6, but for a different time period.

The video processor 48 is used to convert individual data points generated by the processors 46 and 47 (as shown in FIGS. 2 and 3) into a video image showing how the data changes over time.

FIG. 8 shows an exemplary display, indicated by the reference numeral 80, that might be provided by the output of the video processor 8. The display 80 shows how the 2-dimensional data change over time. The representation of FIG. 8 includes two plots: a first plot 82 derived from the output of the first processor 46 (e.g. showing the fault data for San Francisco) and a second plot 84 derived from the output of the second processor 47 (e.g. showing the fault data for Los Angeles).

As with the display 32, the display 70 shows all of the data points display, whereas, of course, the output of the video processor may only show one data point at a time. Furthermore, as with the display 32, the lines joining data points shown in the display 70 may not be output by the video processor (i.e. the processor may only show the determined data points). Alternatively, the lines joining the data points may be generated by an interpolating engine (not shown) that interpolates between data points. Such an arrangement may give a more convincing video output. The interpolating engine may form part of the video processor 48.

The example given in the present application of plotting the total number of system faults and the average time to repair faults is provided by way of example only. The principles of the invention can, of course, be applied to any data set of one or more entities. As explained above, the data can include one, two or three variable (typically plots with one, two or three axes) for one or more entities. The invention could also be applied where there are more than three variables. A fourth variable could, for example, be displayed by using a variably sized bubble location in a three-dimensional space.

The invention has been described with reference to a single entity (FIGS. 1 to 4) and with reference to two entities (FIGS. 5 to 8). Of course, the principles of the invention could apply to any number of data entities.

The embodiments of the invention described above are illustrative rather than restrictive. It will be apparent to those skilled in the art that the above devices and methods may incorporate a number of modifications without departing from the general scope of the invention. It is intended to include all such modifications within the scope of the invention insofar as they fall within the scope of the appended claims.

1. A method comprising:
extracting first data from a first data set, wherein the first data relates to a first variable for a first entity between a first defined start time and a first defined end time;
populating a second data set with said first data;
processing the data included in said second data set to generate a plot value for said variable for each of a plurality of time slices; and
processing said plot values to create a series of images over time of said plot values.

2. A method as claimed in claim 1, further comprising extracting second data from the first data set, wherein the second data relates to a second variable for the first entity between the first defined start time and the first defined end time, wherein:
populating the second data set includes populating the second data set with said second data; and
processing the data included in the second data set includes generating a two-dimensional plot value for said first and second variables for each of a plurality of time slices.

3. A method as claimed in claim 1, further comprising extracting second and third data from the first data set, wherein the second data relates to a second variable for the first entity between the first defined start time and the first defined end time and the third data relates to a third variable for the first entity between the first defined start time and the first defined end time, wherein:
populating the second data set includes populating the second data set with said second and third data; and
processing the data included in the second data includes generating a three-dimensional plot value for said first and second variables for each of a plurality of time slices.

4. A method as claimed in claim 1, further comprising extracting fourth data from the first data set, wherein the fourth data relates to a first variable for a second entity between a second defined start time and a second defined end time;
populating a third data set with said fourth data;
processing the data included in said third data set to generate a plot value for said variable for each of a plurality of time slices; and
processing said plot values to create a series of images over time of said plot values.

5. A method as claimed in claim 4, further comprising extracting fifth data from the first data set, wherein the fifth data relates to a second variable for the second entity between the second defined start time and the second defined end time, wherein:
populating the second data set includes populating the second data set with said second data; and
processing the data included in the second data set includes generating a two-dimensional plot value for said first and second variables for each of a plurality of time slices.

6. A method as claimed in claim 4, further comprising extracting fifth and sixth data from the first data set, wherein the fifth data relates to a second variable for the second entity between the second defined start time and the second defined end time and the sixth data relates to a third variable for the second entity between the second defined start time and the second defined end time, wherein:
populating the second data set includes populating the second data set with said second and third data; and
processing the data included in the second data includes generating a three-dimensional plot value for said first and second variables for each of a plurality of time slices.

7. A method as claimed in claim 1, wherein at least some of the defined start times and/or the defined end times are defined by a user.

8. A method as claimed in claim 1, wherein the series of images over time of said plot values is provided as a video image.

9. A method as claimed in claim 8, further comprising interpolating between adjacent plot values.

10. An apparatus comprising:
a first processor adapted to receive first data from a first data set, wherein the first data relates to a first variable for a first entity between a first defined start time and a first defined end time, wherein the first processor is adapted to generate a plot value for said variable for each of a plurality of time slices;
a second processor adapted to convert a plurality of plot values into a series of images of said plot values over time; and
a display adapted to output the series of images.

11. An apparatus as claimed in claim 10, wherein said second processor is a video processor.

12. An apparatus as claimed in claim 10, wherein said second processor is adapted to interpolate between said plot values.

13. An apparatus as claimed in claim 10, wherein said first processor is adapted to generate a plot value for a second and/or a third variable for the first entity between the first defined start time and the first defined end time.

14. An apparatus as claimed in claim 10, further comprising a third processor, wherein the third processor is adapted to receive fourth data from the first data set, wherein the fourth data relates to a first variable for a second entity between a second defined start time and a second defined end time, wherein:
the third processor is adapted to generate a plot value for said first variable for the second entity for each of a plurality of time slices; and
the second processor is further adapted to convert the plurality of plot values for the first variable for the second entity into a second series of images of said plot values over time; and
the display is further adapted to output the series of images.

15. A computer program product comprising:
means for extracting first data from a first data set, wherein the first data relates to a first variable for a first entity between a first defined start time and a first defined end time;
means for populating a second data set with said first data;
means for processing the data included in said second data set to generate a plot value for said variable for each of a plurality of time slices; and
means for processing said plot values to create an image over time of said plot values.
